(19) United States
(12) Patent Application Publication
(10) Pub. No.: US 2024/0346425 A1
(43) Pub. Date: Oct. 17, 2024

(54) VISUAL ANALYSIS SYSTEM BASED ON DISCIPLINE ASSESSMENT REPORT

(71) Applicant: UNION HOSPITAL, TONGJI MEDICAL COLLEGE, HUAZHONG UNIVERSITY OF SCIENCE AND TECHNOLOGY, WUHAN (CN)

(72) Inventors: QINGSONG WU, WUHAN (CN); YINGCONG ZHANG, WUHAN (CN); MING MA, WUHAN (CN); CAN XIANG, WUHAN (CN); SHI CHEN, WUHAN (CN); JIANCAI WU, WUHAN (CN); YANG JIN, WUHAN (CN); ZHENG WANG, WUHAN (CN); FEI LUO, WUHAN (CN); ZHIHUI WANG, WUHAN (CN)

(21) Appl. No.: 18/702,225

(22) PCT Filed: Sep. 27, 2022
(86) PCT No.: PCT/CN2022/121816

§ 371 Date: Apr. 17, 2024

(30) Foreign Application Priority Data
Jan. 7, 2022 (CN) 202210015384.9

(51) Int. Cl. G06Q 10/0639; G06Q 50/20

(52) U.S. Cl. CPC G06Q 10/06393; G06Q 50/20

(57) ABSTRACT

The present disclosure provides a visual analysis system based on a discipline assessment report, and relates to the technical field of discipline assessment. The visual analysis system based on a discipline assessment report includes a data acquisition unit. An output end of the data acquisition unit is electrically connected to an input end of a data preprocessing unit, and an output end of the data preprocessing unit is electrically connected to an input end of a central processing unit. According to the visual analysis system based on a discipline assessment report, development and changes of the discipline in a project corresponding to the indicator are accurately determined, and a clear plan and development goal are made for overall development of the discipline. Therefore, the overall discipline assessment and a follow-up development process are more clear and distinct.

### CROSS-REFERENCE TO RELATED APPLICATION

The present disclosure is a national stage application of International Patent Application No. PCT/CN2022/121816, filed on Sep. 27, 2022, which claims priority to Chinese Patent Application 202210015384.9, filed on Jan. 7, 2022 and entitled “VISUAL ANALYSIS SYSTEM BASED ON DISCIPLINE ASSESSMENT REPORT”, which is incorporated herein by reference in its entirety.

### TECHNICAL FIELD

The present disclosure relates to the technical field of discipline assessment, and in particular to a visual analysis system based on a discipline assessment report.

### BACKGROUND

Construction and assessment of important disciplines are fundamental work of institutions of higher learning, and effective ways and strategic measures to improve school-running levels of the institutions of higher learning. Assessment on the construction of the important disciplines of the institutions of higher learning is conducive to strengthening guidance and organizational management of the construction of the important disciplines, implementing appropriate allocation and exchange of resources in the important disciplines and between related disciplines, adjusting a structure of the disciplines, and improving overall levels of the disciplines. Recently, educational administrative departments at all levels, colleges and universities, and academics have performed positive explorations on how to scientifically and reasonably perform an impotent discipline assessment by colleges and universities. Although some results are made, there are still many problems. In the present disclosure, a hierarchical analysis method is used to calculate a weight of each assessment indicator, establish an assessment model, and apply the weight of each assessment indicator and the assessment model to practice of management and assessment of the important disciplines of the colleges and universities.

Discipline leaders, academic backbones, and general researchers are required to participate in the construction of the important disciplines. The discipline leaders need to fully understand development statuses, characteristics, and trends of disciplines in or outside a province. domestic or international disciplines, disciplines of a same category or a different category, and same disciplines of similar institutions at a same level or a different level, fully understand current situations, strengths, potentials, advantages, and gaps of the disciplines, guide formulation of development plans for the disciplines, stabilize advantageous research directions, and develop new research directions. The academic backbones and the general researchers conduct related research work under leadership of the discipline leaders, to maintain overall competitiveness of the disciplines. As a core of discipline organizations and discipline teams, the discipline leaders have a decisive role in construction and development of the important disciplines. The discipline leaders may be trained in the colleges and universities or introduced from other colleges and universities. but central positions of the discipline leaders need to be generated in academic organizations, to ensure that the discipline leaders fully exercise academic power without interference from administrative power. In addition, the discipline leaders need to bear responsibilities of maintaining authority and fairness in the academic organizations, and training and forming the discipline teams.

As an important measure to assess effectiveness of the construction and development of the disciplines, importance and influence of discipline assessment have been gradually and widely concerned by the public. It can be found from literature that a concept of discipline assessment appeared early in the western society. which is a direct product after categories of disciplines are divided clearly. Education sectors of western developed countries first realize that in a discipline development process, a scientific and appropriate standard is required to determine and measure effectiveness of construction of the disciplines, to ensure that the disciplines are developed normally. For example, in the United States and Europe, discipline assessment is generally organized by a third-party non-governmental organization (a society and an industry association) in the field of higher education at regular cycle. The institutions of higher learning voluntarily participate in the assessment on the disciplines. An assessment process is subject to supervision, and an assessment result is published in a timely manner, reflecting strong authority. Based on a discipline assessment result, the colleges and universities are promoted to improve overall school-running strength by adjusting construction ideas of the disciplines, optimizing settings of specialties, and improving quality of personnel training, to form a virtuous circle of “assessment promotes improvement, and assessment promotes construction”.

The Ministry of Education has evaluated, according to a first-level discipline, an overall level of a unit with a qualification of training graduates and granting degrees since 2002. Four rounds of assessment have been completed so far. In the fourth round of completed discipline assessment, all parties highly concern controversial results and roles. Although the Ministry of Education repeatedly emphasizes that discipline assessment is performed through “no counting of talents, no ranking”. However, an assessment result with an official background certainly causes subsequent overflow effect. In the next five years, due to the discipline assessment result, the colleges and universities are affected to obtain national competitive research funds, cultivation, and introduction of high-level talents are affected, and employment levels and directions of graduates are affected. In comparison with a third discipline assessment, an indicator system emphasizes management concepts of “quality, effectiveness, characteristics, and classification”. However. discipline assessment performed by the Ministry of Education has orientation and motivation. while construction of the disciplines of the colleges and universities is centered on the indicator system. A process of promoting construction through assessment, helping construction through assessment. and guiding schools to prepare for assessment is failed to be changed into a process of sorting out discipline backgrounds, standardizing management of construction of disciplines, and planning development of the disciplines, and replaced by vigorous, utilitarian, and operational campaigns. The root cause for contradictions of discipline assessment lies in dual-purpose nature of assessment. namely, supporting process-oriented development and improvement, and supporting result-oriented grade evaluation. which are two different assessment activities. An original purpose of assessment values process. However, the indicator system for assessment is totally result-oriented, and the original purpose is opposite to an indicator design. This undoubtedly reflects ambivalence of an authorized party in performing assessment. The authorized party for performing assessment hopes that the colleges and universities autonomously perform examination and reflection, make up for shortcomings, and seek development in a process of preparing for assessment.

Quality of talent cultivation is put in the first place. An assessment model at three dimensions of “quality of cultivation process”, “quality of students at schools”, and “quality of graduates” is established. A pilot survey is first performed on students at schools and employers, to track learning quality of students at schools and quality of career development after graduation. It is necessary to report 15 enrolled undergraduate students having representative achievements of the discipline and 20 postgraduate alumni having representative achievements of the discipline. In terms of an indicator for exchange between students, for outbound exchange between the enrolled undergraduate students or exchange between overseas students in China, only students (including degree students) who have studied for more than 90 days are counted.

Conditions and resources are diluted, and output and effectiveness are highlighted. A single method for assessing a teacher team by “assessing academic levels with academic titles” is changed into a method for listing “representative backbone teachers”. Experts comprehensively examine levels, structures, internationalization, and sustainable development capabilities of the teacher team. Assessment on quality of the teacher team has changed from “counting a quantity of talents” to comparing structures and capabilities. The quantity of talents are not counted, but structures of the teachers and representative figures are compared. A teacher team with an appropriate proportion of old, middle-aged, and young teachers shows sustainable development capabilities of the disciplines. Therefore. when 25 teachers are reported, strength of the teachers is considered, and structures (for example, a quantity of young teachers is not less than 10) are fully considered. An upper limit is set for full-time teachers, and full scores are obtained when the upper limit is achieved. In addition, “a student-teacher ratio” is an indicator in the third round of assessment, but does not appear in an indicator system for the fourth round of assessment.

A method for assessing academic papers through “quantitative and qualitative, domestic and international, quality and quantity”, for example, improving “essential science indicators (ESI) highly cited papers”, and building a brand of “China version of ESI highly cited papers”, to implement more scientific assessment. “ESI discipline classification” corresponds to “Discipline catalog in China”. The top 1% of ESI is extended to the top 3%, to inject Chinese elements into quantitative assessment on quality of academic papers, and reinforce discourse power of assessment on Chinese papers (for example, a quantity of Chinese journal papers in 30 representative papers is not less than 10). Assessment on “structural quality” is added to “representative papers”, and each teacher may only fill in five representative papers.

In terms of transformation of achievements, for authorizations for science and engineering. agriculture science, and medical science counted in the past four years, and transformed or applied invention patents and national defense patents, corresponding application certificates of the achievements need to be provided.

Contribution indicators for social service are increased, and assessment is performed based on “representative cases”, to reflect contribution and characteristics of different regions and types of disciplines on economic and social development of regions. Contribution to social service and discipline reputation is assessed through a peer expert scoring method.

Cross-operations of the disciplines are encouraged, and interdisciplinary achievements are scientifically assessed through a “degree of belonging” method. To be specific, a scientific research achievement of a same scientific researcher may be distributed among the disciplines across the same scientific researcher.

Preparation of teaching materials is included in the scientific research achievements. This mainly implements opinions of the Ministry of Education to strengthen construction of teaching materials, encourages teachers to actively participate in preparation of high-quality teaching materials, and promotes construction quality of discipline infrastructure. However, only national teaching materials that are planned in the “12th Five-Year Plan” and that are published in the last four years may be included in statistics, to highlight representativeness and authority of the teaching materials.

In discipline assessment, result orientation is obvious, and a level of the discipline is obtained based on the overall assessment result. However, impact of the discipline in a specific indicator does not have a specific assessment result. Therefore, an overall development level of the discipline may not be obvious, but development of a single indicator may have obvious advantages. resulting in an incomplete understanding of development and changes in the discipline as a whole. Therefore, a visual analysis system based on a discipline assessment report is needed to resolve the above problems.

### SUMMARY

To resolve the foregoing defects in conventional technologies, the present disclosure provides a visual analysis system based on a discipline assessment report. The above problems are resolved in one or more implementations of the present disclosure. In discipline assessment, result orientation is obvious, and a level of a discipline is obtained based on the overall assessment result. However, impact of the discipline in a specific indicator does not have a specific assessment result. Therefore, an overall development level of the discipline may not be obvious, but development of a single indicator may have obvious advantages, resulting in an incomplete understanding of development and changes in the discipline as a whole.

To achieve the foregoing objective, some implementations of the present disclosure provide a visual analysis system based on a discipline assessment report. The visual analysis system based on a discipline assessment report includes: a data acquisition unit. where an output end of the data acquisition unit is electrically connected to an input end of a data preprocessing unit, an output end of the data preprocessing unit is electrically connected to an input end of a central processing unit, an output end of the central processing unit is electrically connected to an input end of an assessment unit, an output end of the assessment unit is electrically connected to an input end of an assessment result analysis unit, the input end of the assessment result analysis unit is electrically connected to an output end of a data storage unit, an input end of the data storage unit is electrically connected to the output end of the assessment unit, and an output end of the assessment result analysis unit is electrically connected to an input end of a visualization unit.

In some embodiments of the present disclosure, the data acquisition unit is configured to acquire data of a teaching and research team, data of a teaching achievement, data of a scientific research team, data of a scientific research achievement, and a scientific research condition that are related to a discipline. The data preprocessing unit is configured to sort out and unify formats of acquired data. The assessment unit is configured to perform assessment and analysis on a discipline based on acquired data. The assessment result analysis unit is configured to analyze an assessment result, and compare the assessment result with a previous assessment result, to obtain, in a quantity of assessment results, a change and development trend of an assessment result of a discipline corresponding to an indicator. The visualization unit is configured to display an assessment result and an assessment result of an indicator in a visual manner.

In some embodiments of the present disclosure, the data of the teaching and research team includes a disciplinary teaching and research leader and a discipline team. where the disciplinary teaching and research leader includes influence in a teaching field, a representative teaching and research result, and an academic level, the discipline team includes a talent team in which a member of the teaching and research team participates, an overall academic level, and reasonableness of a talent structure, and the talent structure includes an age, a support, an educational background, and a specialty of a person. The teaching achievement includes talent cultivation and a teaching and research achievement, the talent cultivation includes a ratio of enrolled undergraduate students to teachers, a ratio of enrolled postgraduate students to teachers, a ratio of enrolled doctoral students to teachers, and a level of professional construction, a level of paper, and a scientific research achievement of a student during enrollment, and the teaching and research achievement includes an award for a teaching achievement and establishment of a teaching reform task. The data of the scientific research team comprises data of a scientific researcher and a scientific research leader, the data of the scientific researcher includes qualification of members of the scientific research team. reasonableness of a structure of the members of the scientific research team, and a scientific research project, and the scientific research leader includes a scientific research level of the scientific researcher, a scientific research project in which the scientific researcher participates, and a scientific research project that is hosted by the scientific researcher. The data of the scientific research achievement includes a scientific research project and a scientific research achievement. the scientific research project includes significance and a role of study in the scientific research project, the scientific research achievement includes a level of a scientific research achievement. value of paper, an award for scientific research, and conversion of the scientific research achievement; the scientific research condition comprises a scientific research platform and a basic scientific research condition; the scientific research platform includes construction of a scientific research base and construction of a scientific research center; and the basic scientific research condition includes a scientific research instrument and device, library materials, and usage of funds for scientific research.

The assessment unit is configured to perform assessment through an assessment model. Establishment of the assessment model includes the following steps: S1, constructing an incremental hierarchical indicator system for discipline assessment; S2, constructing an inter-factor comparison and judgment matrix; performing comparison between every two factors based on an expert opinion, to obtain a judgment matrix that is constructed by a 1-9 scale method, and judging through a collective discussion method; and S3, performing weighting and a consistency test, where the judgment matrix is constructed based on a hierarchical analysis model and an introduced matrix scale, a largest feature root is calculated, single ranking of each level is conducted, a consistency test on the judgment matrix is performed, and the consistency test is conducted through a square root method including the following steps:

calculating a product

$$\\ {M}_{i} = {\prod }_{j = 1}^{n} \cdot {\prod }_{j = 1}^{n} {b}_{ij} ,$$

i=1,2, . . . , n of elements in each row of the judgment matrix; calculating an n^{th} root M̅₁̅, i=1,2, . . . , n of Mᵢ; performing normalization on a vector W=[W̅₁̅, W̅₂̅, . . . . W̅ₙ̅]^{T}, that is,

$$\\ {W}_{i} = \frac{\overline{{W}_{i}}}{{\sum }_{j = 1}^{n} \overline{Wj}} ,$$

i=1,2, . . . , n; determining W=W̅₁̅, W̅₂̅, . . . . W̅ₙ̅^{T} as a required feature vector; calculating a maximum feature root

$$\\ {λ}_{max} = {\sum }_{i = 1}^{n} \frac{{( AW )}_{i}}{{nW}_{i}} ,$$

(AW)ᵢ of the judgment matrix, and identifying an i^{th} element of a vector AW; verifying consistency of the judgment matrix, where when an order is greater than 2, a ratio of a consistency indicator CI of the judgment matrix to an average random consistency indicator RI of a same order is determined as a random consistency ratio, that is, CR, when

$$\\ CR = \frac{CI}{RI} < 0.1 ,$$

it is determined that the judgment matrix has satisfactory consistency, and for judgment matrices at a first stage and a second stage, consistency needs not to be determined; and performing accumulation on scores of a plurality of assessment indicators, to obtain a mathematical model

$$\\ V = {\sum }_{i = 1}^{m} {C}_{i} {V}_{i}$$

for discipline assessment, where V presents a total score of the assessment for the discipline, Cᵢ presents a weight of the i^{th} assessment indicator, Vᵢ presents a score of each discipline in the i^{th} assessment indicator, and m presents a quantity of assessments indicators.

### BRIEF DESCRIPTION OF THE DRAWINGS

FIG. 1 is a schematic diagram of a system connection according to some embodiments of the present disclosure.

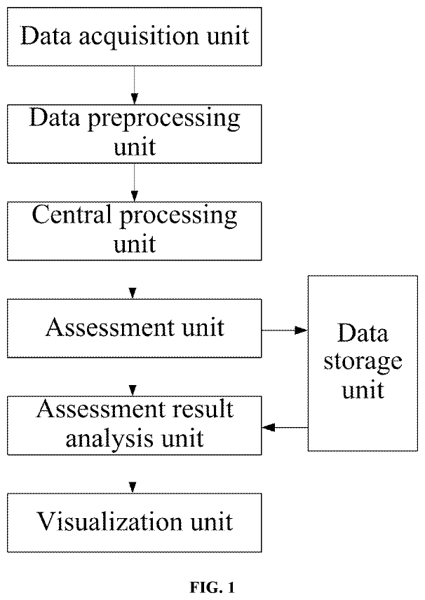

### DETAILED DESCRIPTION OF THE EMBODIMENTS

The following clearly and completely describes the technical solutions in embodiments of the present disclosure with reference to accompanying drawings in embodiments of the present disclosure. Apparently, the described embodiments are merely a part rather than all of embodiments of the present disclosure. All other embodiments obtained by those of ordinary skill in the art based on embodiments of the present disclosure without creative efforts should fall within the protection scope of the present disclosure.

Some implementations of the present disclosure provide a visual analysis system based on a discipline assessment report. The visual analysis system based on a discipline assessment report may include a data acquisition unit. where an output end of the data acquisition unit is electrically connected to an input end of a data preprocessing unit, an output end of the data preprocessing unit is electrically connected to an input end of a central processing unit, an output end of the central processing unit is electrically connected to an input end of an assessment unit, an output end of the assessment unit is electrically connected to an input end of an assessment result analysis unit, the input end of the assessment result analysis unit is electrically connected to an output end of a data storage unit, an input end of the data storage unit is electrically connected to the output end of the assessment unit, and an output end of the assessment result analysis unit is electrically connected to an input end of a visualization unit.

In some embodiments of the present disclosure, the data acquisition unit may be configured to acquire data of a teaching and research team, data of a teaching achievement, data of a scientific research team, data of a scientific research achievement, and a scientific research condition that are related to a discipline. The data preprocessing unit may be configured to sort out and unify formats of acquired data. The assessment unit may be configured to perform assessment and analysis on a discipline based on acquired data. The assessment result analysis unit may be configured to analyze an assessment result, and compare the assessment result with a previous assessment result, to obtain, in a quantity of assessment results, a change and development trend of an assessment result of a discipline corresponding to an indicator. The visualization unit may be configured to display an assessment result and an assessment result of an indicator in a visual manner.

In some embodiments of the present disclosure, the data of the teaching and research team may include a disciplinary teaching and research leader and a discipline team, where the disciplinary teaching and research leader includes influence in a teaching field, a representative teaching and research result, and an academic level, the discipline team includes a talent team in which a member of the teaching and research team participates, an overall academic level, and reasonableness of a talent structure, and the talent structure includes an age, a support, an educational background, and a specialty of a person. The teaching achievement may include talent cultivation and a teaching and research achievement, the talent cultivation includes a ratio of enrolled undergraduate students to teachers, a ratio of enrolled postgraduate students to teachers, a ratio of enrolled doctoral students to teachers, and a level of professional construction, a level of paper, and a scientific research achievement of a student during enrollment, and the teaching and research achievement includes an award for a teaching achievement and establishment of a teaching reform task. The data of the scientific research team may include data of a scientific researcher and a scientific research leader. The data of the scientific researcher may include qualification of members of the scientific research team, reasonableness of a structure of the members of the scientific research team, and a scientific research project. The scientific research leader may include a scientific research level of the scientific researcher, a scientific research project in which the scientific researcher participates, and a scientific research project that is hosted by the scientific researcher. The data of the scientific research achievement may include a scientific research project and a scientific research achievement. The scientific research project may include significance and a role of study in the scientific research project. The scientific research achievement may include a level of a scientific research achievement, value of paper, an award for scientific research, and conversion of the scientific research achievement. The scientific research condition may include a scientific research platform and a basic scientific research condition. The scientific research platform may include construction of a scientific research base and construction of a scientific research center. The basic scientific research condition may include a scientific research instrument and device, library materials, and usage of fund for scientific research.

In some embodiments of the present disclosure, the assessment unit may be configured to perform assessment through an assessment model. Establishment of the assessment model may include the following steps: S1: Construct an incremental hierarchical indicator system for discipline assessment. S2: Construct an inter-factor comparison and judgment matrix; and perform comparison between every two factors based on an expert opinion, to obtain a judgment matrix that is constructed by a 1-9 scale method, and judge through a collective discussion method. S3: Perform weighting and a consistency test. where the judgment matrix is constructed based on a hierarchical analysis model and an introduced matrix scale, a largest feature root is calculated. single ranking of each level is performed, and a consistency test on the judgment matrix is conducted. The consistency test is conducted through a square root method including the following steps: calculating a product of elements in each row of the judgment matrix; calculating a product

$$\\ {M}_{i} = {\prod }_{j = 1}^{n} \cdot {\prod }_{j = 1}^{n} {b}_{ij} ,$$

i=1,2, . . . , n of elements in each row of the judgment matrix; calculating an n^{th} root M̅₁̅, i=1,2, . . . , n of Mᵢ; performing normalization on a vector W=[W̅₁̅, W̅₂̅, . . . . W̅ₙ̅]^{T}, that is,

$$\\ {W}_{i} = \frac{\overline{{W}_{i}}}{{\sum }_{j = 1}^{n} \overline{Wj}} ,$$

i=1,2, . . . , n; determining W=W̅₁̅, W̅₂̅, . . . . W̅ₙ̅^{T} as a required feature vector; calculating a maximum feature root

$$\\ {λ}_{max} = {\sum }_{i = 1}^{n} \frac{{( AW )}_{i}}{{nW}_{i}} ,$$

(AW)ᵢ of the judgment matrix, and identifying an i^{th} element of a vector AW; verifying consistency of the judgment matrix, where when an order is greater than 2, a ratio of a consistency indicator CI of the judgment matrix to an average random consistency indicator RI of a same order is determined as a random consistency ratio, that is, CR, when

$$\\ CR = \frac{CI}{RI} < 0.1 ,$$

it is determined that the judgment matrix has satisfactory consistency, and for judgment matrices at a first stage and a second stage, consistency needs not to be determined; and performing accumulation on scores of a plurality of assessment indicators, to obtain a mathematical model

$$\\ V = {\sum }_{i = 1}^{m} {C}_{i} {V}_{i}$$

for discipline assessment, where V presents a total score of the assessment for the discipline, Cᵢ presents a weight of the i^{th} assessment indicator, Vᵢ presents a score of each discipline in the i^{th} assessment indicator, and m presents a quantity of assessments indicators.

In conclusion, in the present disclosure, the assessment result can be analyzed through the assessment module, the visualization unit, and the assessment result analysis unit, and in the assessment result, the assessment result of each indicator of the discipline is specifically divided. In addition, a corresponding chart is generated in combination with the assessment result of the indicator of the discipline and historical data of the overall assessment result, reflecting changes in the assessment result of the discipline as a whole. Furthermore, development and changes of the discipline in a project corresponding to the indicator are accurately determined, and a clear plan and development goal are made for overall development of the discipline. Therefore, the overall discipline assessment and a follow-up development process are more clear and distinct.

The present disclosure can clearly specify the indicators of the discipline through corresponding indicators for the discipline, compare corresponding factors based on corresponding expert opinions, establish the judgment matrix, and perform determining through the collective discussion method, so that errors caused by different expert opinions are overcome, to enable the overall assessment result to be more scientific and appropriate.

Finally, it is still necessary to be noted that first of all, in accompanying drawings of embodiments of the present disclosure, merely a structure related to embodiments of the present disclosure is involved, reference can be made to general design for other structures, and the same embodiment and different embodiments of the present disclosure can be combined with each other without conflict.

The foregoing descriptions are merely optional embodiments of the present disclosure and are not intended to limit the present disclosure. Any modification, equivalent replacement, and improvement within the spirit and principle of the present disclosure shall be included within the protection scope of the present disclosure.

What is claimed is:

1. A visual analysis system based on a discipline assessment report, comprising: a data acquisition unit, wherein an output end of the data acquisition unit is electrically connected to an input end of a data preprocessing unit, an output end of the data preprocessing unit is electrically connected to an input end of a central processing unit, an output end of the central processing unit is electrically connected to an input end of an assessment unit, an output end of the assessment unit is electrically connected to an input end of an assessment result analysis unit, the input end of the assessment result analysis unit is electrically connected to an output end of a data storage unit, an input end of the data storage unit is electrically connected to the output end of the assessment unit, and an output end of the assessment result analysis unit is electrically connected to an input end of a visualization unit.

2. The visual analysis system based on a discipline assessment report according to claim 1, wherein the data acquisition unit is configured to acquire data of a teaching and research team, data of a teaching achievement, data of a scientific research team, data of a scientific research achievement, and a scientific research condition that are related to a discipline.

3. The visual analysis system based on a discipline assessment report according to claim 1, wherein the data preprocessing unit is configured to sort out and unify formats of acquired data.

4. The visual analysis system based on a discipline assessment report according to claim 1, wherein the assessment unit is configured to perform assessment and analysis on a discipline based on acquired data.

5. The visual analysis system based on a discipline assessment report according to claim 1, wherein the assessment result analysis unit is configured to analyze an assessment result, and compare the assessment result with a previous assessment result, to obtain, in a quantity of assessment results, a change and development trend of an assessment result of a discipline corresponding to an indicator.

6. The visual analysis system based on a discipline assessment report according to claim 1, wherein the visualization unit is configured to display an assessment result and an assessment result of an indicator in a visual manner.

7. The visual analysis system based on a discipline assessment report according to claim 2. wherein the data of the teaching and research team comprises a disciplinary teaching and research leader and a discipline team. wherein the disciplinary teaching and research leader comprises influence in a teaching field, a representative teaching and research result, and an academic level. the discipline team comprises a talent team in which a member of the teaching and research team participates, an overall academic level, and reasonableness of a talent structure, and the talent structure comprises an age, a support, an educational background, and a specialty of a person.

8. The visual analysis system based on a discipline assessment report according to claim 2. wherein the teaching achievement comprises talent cultivation and a teaching and research achievement, the talent cultivation comprises a ratio of enrolled undergraduate students to teachers. a ratio of enrolled postgraduate students to teachers, a ratio of enrolled doctoral students to teachers. and a level of professional construction, a level of paper, and a scientific research achievement of a student during enrollment, and the teaching and research achievement comprises an award for a teaching achievement and establishment of a teaching reform task.

9. The visual analysis system based on a discipline assessment report according to claim 2. wherein the data of the scientific research team comprises data of a scientific researcher and a scientific research leader, the data of the scientific researcher comprises qualification of members of the scientific research team, reasonableness of a structure of the members of the scientific research team, and a scientific research project, and the scientific research leader comprises a scientific research level of the scientific researcher, a scientific research project in which the scientific researcher participates, and a scientific research project that is hosted by the scientific researcher; the data of the scientific research achievement comprises a scientific research project and a scientific research achievement, the scientific research project comprises significance and a role of study in the scientific research project, the scientific research achievement comprises a level of a scientific research achievement, value of paper, an award for scientific research, and conversion of the scientific research achievement; the scientific research condition comprises a scientific research platform and a basic scientific research condition; the scientific research platform comprises construction of a scientific research base and construction of a scientific research center; and the basic scientific research condition comprises a scientific research instrument and device, library materials, and usage of fund for scientific research.

10. The visual analysis system based on a discipline assessment report according to claim 1. wherein the assessment unit is configured to perform assessment through an assessment model, and the assessment model is established according to the following steps:
S1, constructing an incremental hierarchical indicator system for discipline assessment;
S2, constructing an inter-factor comparison and judgment matrix; performing comparison between every two factors based on an expert opinion, to obtain a judgment matrix that is constructed by a 1-9 scale method, and judging through a collective discussion method; and
S3, performing weighting and a consistency test, wherein the judgment matrix is constructed based on a hierarchical analysis model and an introduced matrix scale, a largest feature root is calculated, single ranking of each level is performed, a consistency test on the judgment matrix is conducted, and the consistency test is conducted by a square root method comprising the following steps;
calculating a product
$$\\ {M}_{i} = {\prod }_{j = 1}^{n} \cdot {\prod }_{j = 1}^{n} {b}_{ij} ,$$
i=1,2, . . . , n of elements in each row of the judgment matrix;
calculating an n^{th} root M̅₁̅, i=1,2, . . . , n of Mᵢ;
performing normalization on a vector W=[W̅₁̅, W̅₂̅, . . . . W̅ₙ̅]^{T}, that is,
$$\\ {W}_{i} = \frac{\overline{{W}_{i}}}{{\sum }_{j = 1}^{n} \overline{Wj}} ,$$
i=1,2, . . . , n;
determining W=W̅₁̅, W̅₂̅, . . . . W̅ₙ̅^{T} as a required feature vector;
calculating a maximum feature root
$$\\ {λ}_{max} = {\sum }_{i = 1}^{n} \frac{{( AW )}_{i}}{{nW}_{i}} ,$$
(AW)ᵢ of the judgment matrix, and identifying an i^{th} element of a vector AW;
verifying consistency of the judgment matrix, where when an order is greater than 2, a ratio of a consistency indicator CI of the judgment matrix to an average random consistency indicator RI of a same order is determined as a random consistency ratio, that is, CR, when
$$\\ CR = \frac{CI}{RI} < 0.1 ,$$
it is determined that the judgment matrix has satisfactory consistency, and for judgment matrices at a first stage and a second stage, consistency needs not to be determined; and
performing accumulation on scores of a plurality of assessment indicators, to obtain a mathematical model
$$\\ V = {\sum }_{i = 1}^{m} {C}_{i} {V}_{i}$$
for discipline assessment, where V presents a total score of the assessment for the discipline, Cᵢ presents a weight of the i^{th} assessment indicator, Vᵢ presents a score of each discipline in the i^{th} assessment indicator, and m presents a quantity of assessments indicators.
